(19) United States
(12) Patent Application Publication
(10) Pub. No.: US 2024/0412135 A1
(43) Pub. Date: Dec. 12, 2024

(54) AI-BASED INTELLIGENT WORKFLOW IMPROVEMENT

(71) Applicant: International Business Machines Corporation, Armonk, NY (US)

(72) Inventors: Lucia Larise Stavarache, Columbus, OH (US); Stan Kevin Daley, Espanola, NM (US); Jill S. Dhillon, Jupiter, FL (US); Madhusmita Patil, Hyderabad (IN); Jennifer M. Hatfield, Portland, OR (US); Marina-Adriana Mercioni, Timisoara (RO)

(21) Appl. No.: 18/332,800

(22) Filed: Jun. 12, 2023

(51) Int. Cl. G06Q 10/0631; G06N 20/00

(52) U.S. Cl. CPC G06Q 10/06316; G06N 20/00

(57) ABSTRACT

A process for artificial intelligence (AI)-based intelligent workflow improvement monitors and records progressions of users through an intelligent workflow (IW). The IW includes computerized activities through which the users progress through interactions with the IW via graphical user interfaces. The process extracts features of the monitored and recorded progressions as reflected by the stored data records. The process builds and trains at least one AI model using the extracted features. The process generates, using the at least one AI model, customized recommendations for improvement of the IW. The customized recommendations include a training action for presentation to a user progressing though the IW. The process also outputs the customized recommendations. The outputting includes dynamically presenting the training action to the user on a graphical user interface through which the user interacts with the IW as part of progressing through the IW.

### BACKGROUND

This disclosure relates generally to intelligent workflows, and more particularly to approaches and facilities for artificial intelligence (AI)-based intelligent workflow improvement.

An intelligent workflow refers to the orchestration of automation, artificial intelligence, analytics, and skills to change how work gets done, often with a goal of driving efficiency in the completion of activities and management of the underlying workflow through the use of advanced technologies, automation, and data analysis. These activities also provide insights into optimizing the processes involved and potentially those of other workflows. Various industries, including the banking, healthcare, and retail industries, among others, implement and use intelligent workflows.

### SUMMARY

Shortcomings of the prior art are overcome and additional advantages are provided through the provision of a computer-implemented method. The method includes monitoring and recording progressions of users through an intelligent workflow. The intelligent workflow includes computerized activities through which the users progress through interactions with the intelligent workflow via graphical user interfaces. The recording produces stored data records. The method also includes extracting features of the monitored and recorded progressions as reflected by the stored data records. The method also includes building and training at least one artificial intelligence (AI) model using the extracted features. The method additionally includes generating, using the at least one AI model, customized recommendations for improvement of the intelligent workflow. The customized recommendations include a training action for presentation to a user progressing though the intelligent workflow. The method further includes outputting the customized recommendations. The outputting includes dynamically presenting the training action to the user on a graphical user interface through which the user interacts with the intelligent workflow as part of progressing through the intelligent workflow.

Additionally, a computer system is provided that includes a memory and a processor in communication with the memory. The computer system is configured to perform a method that includes monitoring and recording progressions of users through an intelligent workflow. The intelligent workflow includes computerized activities through which the users progress through interactions with the intelligent workflow via graphical user interfaces. The recording produces stored data records. The method also includes extracting features of the monitored and recorded progressions as reflected by the stored data records. The method also includes building and training at least one artificial intelligence (AI) model using the extracted features. The method additionally includes generating, using the at least one AI model, customized recommendations for improvement of the intelligent workflow. The customized recommendations include a training action for presentation to a user progressing though the intelligent workflow. The method further includes outputting the customized recommendations. The outputting includes dynamically presenting the training action to the user on a graphical user interface through which the user interacts with the intelligent workflow as part of progressing through the intelligent workflow.

Further, a computer program product is provided that includes a computer readable storage medium readable by a processing circuit and storing instructions for execution by the processing circuit to perform a method. The method includes monitoring and recording progressions of users through an intelligent workflow. The intelligent workflow includes computerized activities through which the users progress through interactions with the intelligent workflow via graphical user interfaces. The recording produces stored data records. The method also includes extracting features of the monitored and recorded progressions as reflected by the stored data records. The method also includes building and training at least one artificial intelligence (AI) model using the extracted features. The method additionally includes generating, using the at least one AI model, customized recommendations for improvement of the intelligent workflow. The customized recommendations include a training action for presentation to a user progressing though the intelligent workflow. The method further includes outputting the customized recommendations. The outputting includes dynamically presenting the training action to the user on a graphical user interface through which the user interacts with the intelligent workflow as part of progressing through the intelligent workflow.

In some embodiments, the extracted features include detected bottlenecks to progression through the intelligent workflow. In these, and/or alternative, embodiments, the extracted features include features of successful interactions with the intelligent workflow, the building and training the at least one AI model trains an AI model, using the features of successful interactions, to generate the training action to be presented based on detecting a bottleneck of the detected bottlenecks, and the outputting includes dynamically presenting the training action to the user based on actual or predicted presence of the bottleneck in the user progressing through the intelligent workflow. In any of the foregoing, and/or alternative, embodiments, the AI model learns, based on the training using the features of the successful interactions, how the bottleneck may be avoided.

In any of the foregoing, and/or alternative embodiments, the detected bottlenecks include at least one of: (i) time to complete one or more computerized activities of the plurality of computerized activities; (ii) time to complete one or more steps of the intelligent workflow; (iii) number of steps of the intelligent workflow; (iv) number of activities of the intelligent workflow; (v) number of trials on a step of the intelligent workflow; (vi) number of trials of the intelligent workflow; (vii) number of interactions with an AI-based assistant; and (viii) rate of termination in progressing through the intelligent workflow.

In any of the foregoing, and/or alternative, embodiments, the at least one AI model includes an AI model configured to classify, based on interactions of the user, an expertise level of the user, and identify a ranking of potential bottlenecks to the user in progressing through the intelligent workflow.

In any of the foregoing, and/or alternative, embodiments, the at least one AI model includes an AI model configured to classify instances of unsuccessful progression through the intelligent workflow by severity.

In any of the foregoing, and/or alternative, embodiments, the method further includes grouping the interactions based on at least one of: (i) user type and (ii) industry for which the intelligent workflow is deployed. Optionally, the generating produces customized recommendations that vary across at least one of (i) different user types and (ii) different industries.

In any of the foregoing, and/or alternative, embodiments the method further includes repeating, for each additional intelligent workflow of a plurality of additional intelligent workflows: the monitoring and recording progressions; and the extracting features, to produce additional sets of extracted features. Optionally, the building and training the at least one AI model uses the additional sets of extracted features. In any of the foregoing, and/or alternative, embodiments, the method further includes using the at least one AI model to generate customized recommendations for at least one of: (i) improvement in one or more existing intelligent workflows and (ii) design of one or more intelligent workflows to be developed and deployed.

In any of the foregoing, and/or alternative, embodiments, the recording includes producing, as at least some of the stored data records, at least one of: (i) logs, (ii) screen recordings, (iii) voice recordings, and (iv) helpdesk conversations.

In any of the foregoing, and/or alternative, embodiments, the training action includes provision of at least one of: (i) a video, (ii) a text communication, and (iii) a chat session.

In any of the foregoing, and/or alternative, embodiments, the monitoring and recording monitors results of the dynamically presenting the training action to the user, the results providing feedback as to whether the training action is helpful in progressing though the intelligent workflow. In any of the foregoing, and/or alternative, embodiments, the method further includes recording a video of interactions by the user in conjunction with the dynamic presentation of the training action, and providing the video as part of the results, where the generating generates a customized recommendation, of the customized recommendations, to include the video.

In any of the foregoing, and/or alternative, embodiments, a customized recommendation of the customized recommendations includes a recommended modality for users to consume the intelligent workflow in order to optimize their engagement with the intelligent workflow.

In any of the foregoing, and/or alternative, embodiments, the customized recommendations include at least one of: (i) a recommendation to modify a step of the intelligent workflow and (ii) a recommendation to supplement a step of the intelligent workflow with the training action.

The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example process implemented using an intelligent workflow;

FIG. 3 depicts a conceptual diagram of the relation and flow between components of an intelligent system in accordance with aspects described herein;

FIG. 4 depicts an example process for AI-based intelligent workflow improvement, in accordance with aspects described herein; and

FIG. 5 depicts further details of an example intelligent workflow improvement module to incorporate and/or use aspects described herein.

### DETAILED DESCRIPTION

Described herein are approaches and facilities for AI-based intelligent workflow improvement. In an embodiment, a computer-implemented method is provided that includes monitoring and recording progressions of users through an intelligent workflow, the intelligent workflow including a plurality of computerized activities through which the users progress through interactions with the intelligent workflow via graphical user interfaces, and the recording producing stored data records. The method also includes extracting features of the monitored and recorded progressions as reflected by the stored data records. The method additionally includes building and training at least one artificial intelligence (AI) model using the extracted features. The method further includes generating, using the at least one AI model, customized recommendations for improvement of the intelligent workflow, the customized recommendations including a training action for presentation to a user progressing though the intelligent workflow. Additionally, the method includes outputting the customized recommendations, the outputting including dynamically presenting the training action to the user on a graphical user interface through which the user interacts with the intelligent workflow as part of progressing through the intelligent workflow. An advantage of the method is that it provides a lifecycle for improvement of existing, deployed intelligent workflows, restructuring of existing intelligent workflows for new applications, industries, modalities, etc., and insights to apply when developing new intelligent workflows. Such improvement in intelligent workflows has technical effects of increasing efficiency in data and digital communication between computer systems engaging in and/or hosting processing of the workflow steps and activities. Improvements provide reduced session durations, retry attempts, repeated communications, and the like, and improve transaction processing, which in turn reduces processing power and resources needed in executing the intelligent workflows. Additional improvements are provided in the form of optimized automated training systems, and smarter and more effective AI assistants and chatbots.

The extracted features can include detected bottlenecks to progression through the intelligent workflow, providing an advantage in that the features can train model(s) directed to addressing/overcoming these bottlenecks with customized recommendations, for instance training actions, that are tailored to targeted intelligent workflows and can possibly avoid the bottlenecks altogether.

The extracted features can include features of successful interactions with the intelligent workflow, where the building and training the at least one AI model trains an AI model, using the features of successful interactions, to generate the training action to be presented based on detecting a bottleneck of the detected bottlenecks, and where the outputting includes dynamically presenting the training action to the user based on actual or predicted presence of the bottleneck in the user progressing through the intelligent workflow. This provides an advantage in that it helps ensure that the learned and recommended training actions are expected to be more effective in successfully preventing and/or addressing bottlenecks. For instance, the AI model can learn, based on the training using the features of the successful interactions, how the bottleneck may be avoided.

The detected bottlenecks can include at least one of: (i) time to complete one or more computerized activities of the plurality of computerized activities; (ii) time to complete one or more steps of the intelligent workflow; (iii) number of steps of the intelligent workflow; (iv) number of activities of the intelligent workflow; (v) number of trials (i.e., attempts) on a step of the intelligent workflow; (vi) number of trials (i.e., attempts) of the intelligent workflow; (vii) number of interactions with an AI-based assistant; and (viii) rate of termination in progressing through the intelligent workflow, all of which have an advantage of highlighting steps and/or activities of the intelligent workflow(s) that can be targeted and prioritized for addressing with customized recommendations to improve any or all of the foregoing as desired.

The at least one AI model can include an AI model configured to classify, based on interactions of the user, an expertise level of the user, and identify a ranking of potential bottlenecks to the user in progressing through the intelligent workflow, which provides an advantage in that it can be used to prioritize which bottlenecks are most important to address with customized recommendations, in order to proactively avoid them in subsequent intelligent workflow progressions and/or reactively address them with provision of training actions.

The at least one AI model can include an AI model configured to classify instances of unsuccessful progression through the intelligent workflow by severity, which provides an advantage in that it helps a system to automatically prioritize tickets resulting or arising from unsuccessful progression through the workflow, and can help inform where efforts to generate and output customized recommendations should be focused.

The method can further include grouping the interactions based on at least one of (i) user type and (ii) industry for which the intelligent workflow is deployed, where the generating produces customized recommendations that vary across at least one of (i) different user types and (ii) different industries. This has an advantage in that it helps produce more targeted customized recommendations, tailored for specific user types/industries, so that the best recommendations are made to a given user type or industry.

The method can further include repeating, for each additional intelligent workflow of a plurality of additional intelligent workflows: the monitoring and recording progressions, and the extracting features, to produce additional sets of extracted features, where the building and training the at least one AI model uses the additional sets of extracted features. Training based on the additional intelligent workflows has an advantage in that recommendations learned based on interactions with one or a group of intelligent workflows can be put to the benefit other intelligent workflows, either existing or to be developed. For instance, the method can use at least one AI model to generate customized recommendations for at least one of (i) improvement in one or more existing intelligent workflows and (ii) design of one or more intelligent workflows to be developed and deployed.

The recording can include producing, as at least some of the stored data records, at least one of (i) logs, (ii) screen recordings, (iii) voice recordings, and (iv) helpdesk conversations, which has an advantage in that it provides for the capture different types of interactions across varying modalities through which users might interact with the intelligent workflow, and therefore captures a better quality sample set of user interactions.

The training action can include provision of at least one of (i) a video, (ii) a text communication, and (iii) a chat session. This provides varying types of assistance and approaches for training, thereby tailoring the training to different types of individuals who might train better through different approaches, and thus making automated training more efficient and directed to the individual users who need it.

The monitoring and recording can monitor results of the dynamically presenting the training action to the user, the results providing feedback as to whether the training action is helpful in progressing though the intelligent workflow. This has an advantage in that the feedback can be studied and used for later training, and possibly as example training action(s) to present to other user(s) to thereby facilitate the progression thereof through the intelligent workflow. For instance, the method can include recording a video of interactions by the user in conjunction with the dynamic presentation of the training action, and providing the video as part of the results, where the generating generates a customized recommendation, of the customized recommendations, to include the video.

A customized recommendation of the customized recommendations can include a recommended modality for users to consume the intelligent workflow in order to optimize their engagement with the intelligent workflow. Recommending a modality has an advantage in that it can inform the modality on which a provider of the intelligent workflow or entity deploying the intelligent workflow should focus in terms of strengthening and improving the intelligent workflow and in generating and outputting recommendations.

The customized recommendations can include at least one of (i) a recommendation to modify a step of the intelligent workflow and (ii) a recommendation to supplement a step of the intelligent workflow with the training action. This provides an advantage in that, in addition to assisting users progress through an existing workflow, it provides improvements to avoid/correct existing inefficiencies in the existing workflow and thereby reduce resource spend associated with providing automated helpdesk and assistance to users experiencing problems progressing through the intelligent workflow.

In another embodiment, a computer system is provided that includes a memory, and a processor in communication with the memory. The computer system is configured to perform a method that includes monitoring and recording progressions of users through an intelligent workflow, the intelligent workflow including a plurality of computerized activities through which the users progress through interactions with the intelligent workflow via graphical user interfaces, and the recording producing stored data records. The method also includes extracting features of the monitored and recorded progressions as reflected by the stored data records. The method additionally includes building and training at least one artificial intelligence (AI) model using the extracted features. The method further includes generating, using the at least one AI model, customized recommendations for improvement of the intelligent workflow, the customized recommendations including a training action for presentation to a user progressing though the intelligent workflow. Additionally, the method includes outputting the customized recommendations, the outputting including dynamically presenting the training action to the user on a graphical user interface through which the user interacts with the intelligent workflow as part of progressing through the intelligent workflow. An advantage of the method is that it provides a lifecycle for improvement of existing, deployed intelligent workflows, restructuring of existing intelligent workflows for new applications, industries, modalities, etc., and insights to apply when developing new intelligent workflows. Such improvement in intelligent workflows has technical effects of increasing efficiency in data and digital communication between computer systems engaging in and/or hosting processing of the workflow steps and activities. Improvements provide reduced session durations, retry attempts, repeated communications, and the like, and improve transaction processing, which in turn reduces processing power and resources needed in executing the intelligent workflows. Additional improvements are provided in the form of optimized automated training systems, and smarter and more effective AI assistants and chatbots.

In an embodiment of the computer system, the extracted features can include detected bottlenecks to progression through the intelligent workflow, providing an advantage in that the features can train model(s) directed to addressing/overcoming these bottlenecks with customized recommendations, for instance training actions, that are tailored to targeted intelligent workflows and can possibly avoid the bottlenecks altogether. In some embodiments, the extracted features further include features of successful interactions with the intelligent workflow, where the building and training the at least one AI model trains an AI model, using the features of successful interactions, to generate the training action to be presented based on detecting a bottleneck of the detected bottlenecks, and where the outputting includes dynamically presenting the training action to the user based on actual or predicted presence of the bottleneck in the user progressing through the intelligent workflow, and this provides an advantage in that it helps ensure that the learned and recommended training actions are expected to be more effective in successfully preventing and/or addressing bottlenecks. For instance, the AI model can learn, based on the training using the features of the successful interactions, how the bottleneck may be avoided.

In an embodiment of the computer system, the method further includes repeating, for each additional intelligent workflow of a plurality of additional intelligent workflows: the monitoring and recording progressions, and the extracting features, to produce additional sets of extracted features, where the building and training the at least one AI model uses the additional sets of extracted features. Training based on the additional intelligent workflows has an advantage in that recommendations learned based on interactions with one or a group of intelligent workflows can be put to the benefit other intelligent workflows, either existing or to be developed. For instance, the method can use at least one AI model to generate customized recommendations for at least one of: (i) improvement in one or more existing intelligent workflows and (ii) design of one or more intelligent workflows to be developed and deployed.

In yet another embodiment, a computer program product is provided that includes a computer readable storage medium readable by a processing circuit and storing instructions for execution by the processing circuit to perform a method that includes monitoring and recording progressions of users through an intelligent workflow, the intelligent workflow including a plurality of computerized activities through which the users progress through interactions with the intelligent workflow via graphical user interfaces, and the recording producing stored data records. The method also includes extracting features of the monitored and recorded progressions as reflected by the stored data records. The method additionally includes building and training at least one artificial intelligence (AI) model using the extracted features. The method further includes generating, using the at least one AI model, customized recommendations for improvement of the intelligent workflow, the customized recommendations including a training action for presentation to a user progressing though the intelligent workflow. Additionally, the method includes outputting the customized recommendations, the outputting including dynamically presenting the training action to the user on a graphical user interface through which the user interacts with the intelligent workflow as part of progressing through the intelligent workflow. An advantage of the method is that it provides a lifecycle for improvement of existing, deployed intelligent workflows, restructuring of existing intelligent workflows for new applications, industries, modalities, etc., and insights to apply when developing new intelligent workflows. Such improvement in intelligent workflows has technical effects of increasing efficiency in data and digital communication between computer systems engaging in and/or hosting processing of the workflow steps and activities. Improvements provide reduced session durations, retry attempts, repeated communications, and the like, and improve transaction processing, which in turn reduces processing power and resources needed in executing the intelligent workflows. Additional improvements are provided in the form of optimized automated training systems, and smarter and more effective AI assistants and chatbots.

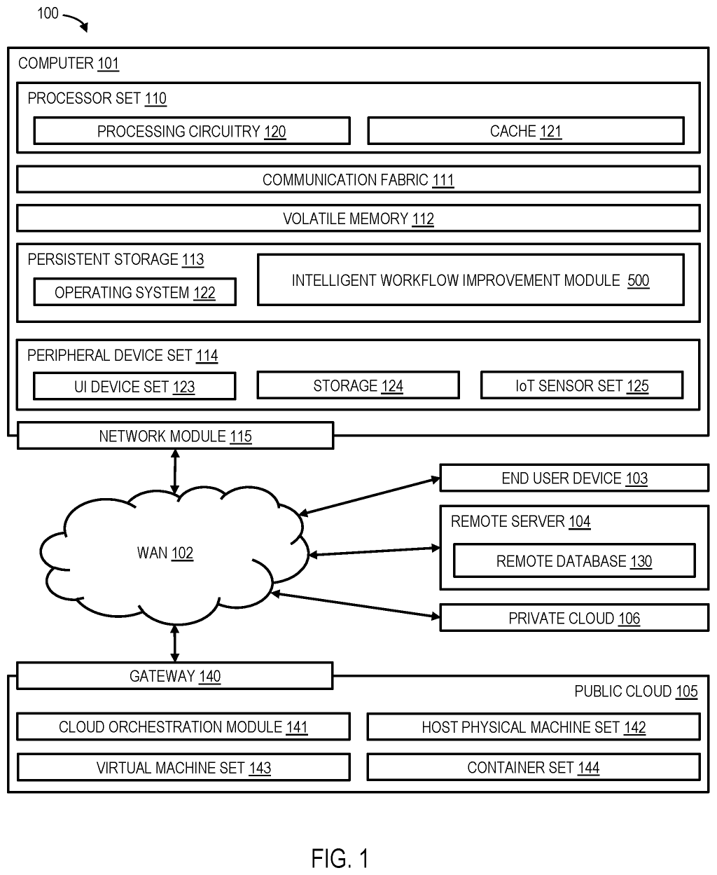

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing aspects of the present disclosure, such as code of intelligent workflow improvement module 500. In addition to block 500, computing environment 100 includes, for example, computer 101. wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 500, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 121 and the other storage media discussed below. The program instructions, and associated data, are accessed by processor set 110 to control and direct performance of the disclosed methods. In computing environment 100, at least some of the instructions for performing the disclosed methods may be stored in block 500 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 500 typically includes at least some of the computer code involved in performing the disclosed methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the disclosed methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

A provider of intelligent workflows might work with its clients to develop new intelligent workflow(s) and/or identify existing intelligent workflow(s) from which to work to achieve client goals. In this context, a provider often recommends one or more intelligent workflows to deploy based on information that the client provides. The provider might also analyze how deployments of recommended intelligent workflows have suited its clients and learn from that activity. Through this, the provider builds a portfolio of intelligent workflows as assets that could be reused for other clients and/or application, possibly with some tweaking based on each client's particular industry, characteristics of the users of the intelligent workflows, and/or other situational factors.

In embodiments discussed herein, a provider has clients that have applied intelligent workflow(s), meaning the activity steps, people roles, and events have been implemented, usually across various digital channels, and the interactions of users with those intelligent workflow(s) can be monitored and analyzed. Interactions in terms of user progression through an intelligent workflow are instances of a user attempting to progress further through the intelligent workflow, for instance from one step or activity to another.

By way of example, an intelligent workflow might be deployed in a situation in which a bank desires to provide its customers the ability to open a bank account online. Such is common in situations where a traditional bank desires to move more of its services into the digital realm and offer its customers the opportunity and experience of, e.g., opening a new bank account, without entering a branch location. The bank might approach a provider to assist with this task, and the provider might propose a new or existing intelligent workflow for opening an account. In this regard, it is possible that an existing intelligent workflow could be reused (with some tweaking) to tailor that existing intelligent workflow to the particular application (banking account) and/or particular client (bank). The provider will often generate the experience using the intelligent workflow and deploy the intelligent workflow for web, mobile, and/or other engagement by users (bank customers in this case). In general, a user interacts with an intelligent workflow via a user interface, such as a graphical user interface, on a user computer system/device, though in some cases a user could progress through an intelligent workflow using another system, such as a telephone system. The intelligent workflow includes computerized activities, which may be performed by/on a collection of devices. In the context of opening a bank account, the computerized activities might include (i) a setup of account information or relation of existing account information for the user relative to the desired task of opening an account, (ii) agreement to account terms, and (iii) a transfer of funds into the account, as examples. The user progresses through the computerized activities by interacting with the intelligent workflow via the user interface on a user device. Often, such interactions are at least partially implemented as communications flowing between the user device and a backend system/server that controls progression through the intelligent workflow.

At this point, as users work with the deployed intelligent workflow, the provider (or another entity) can monitor the success of the intelligent workflow. ‘Success’ could be defined and measured in different ways. In the example above, a measure could be the percentage of users who complete the process of opening an account once the process is started. The measure of attempted account openings occurring online via the intelligent workflow could be compared to a measure of attempted account openings occurring in branches.

In accordance with features described herein, aspects apply intelligence to monitored interactions taken at various steps of user progression through intelligent workflows to learn, across intelligent workflow deployments for potentially various entities and entity types, the characteristics of the intelligent workflows, including characteristics like bottlenecks, effectiveness, market appropriateness, best modalities to use, and others. Insights can be gleaned from these characteristics and grouped by any desired property, for instance deployment region of the workflow, client type, user type, industry involved, and others.

In addition, aspects provide for monitoring interactions to identify potential problems. Example problems are unacceptable dwell times or stuck transactions, though many others exist. Aspects can apply learned help patterns in an attempt to help users in such situations. For instance, a process might automatically invoke an assistant to begin by asking the user if the assistant can assist the user in progressing through the intelligent workflow, and then offering a best approach for addressing the recognized problem. The assistant could be and AI-based assistant and/or supported by AI model(s) that are trained by learning how the problem has been addressed, successfully and unsuccessfully, in the past, and what, specifically, has been previously successful in resolving the problem. Help patterns can be automatically generated based on this learning. Additionally, help patterns could be generic or specific to given types of industries, clients, users, and so on. For instance, a help pattern that works best for a particular type of user, client, or industry might not work the best for another type of user, client, or industry.

After engaging with a user, aspects can monitor whether that engagement was successful. The user might complete the intelligent workflow successfully or might not. Such outcomes provide or inform measurements of performance/success. In examples, financial performance of the intelligent workflow can be assessed and compared to set expectations, goals, and/or to metrics of traditional engagements (e.g., face-to-face bank branch interactions). For instance, if an intelligent workflow to open a bank account online is resulting in several unsuccessful interactions, decreased customer satisfaction, and overburdening the bank's help center, such measurements can be compared to those associated with in-person account openings.

With a host of gathered information at hand and features extracted from the information, insights can be harvested. Customized recommendations can be made as to the best way to use, implement, improve, develop, deploy, manage, train on, etc., given intelligent workflows. The learned insights can be used to improve existing intelligent workflows, suggest best practices for intelligent workflows to be developed, and most effectively train support entities (personnel, virtual assistants, etc.) because of the insights learned from the features extracted from the monitored interactions with this intelligent workflow and potentially other intelligent workflows.

Applying an intelligent workflow does not always lead to an improved user experience and adoption. There are various reasons why this may be the case. In some situations, the time to perform an action/transaction is unacceptably long, the action/transaction becomes stuck or unfinished, and this leads to disengagement and potential loss of a customer, and/or extra cost due to the involvement of a helpdesk or other agent/personnel. Usability issues due to complex processes or processes that do not work, as well as user experience issues, such as lack of flexibility, can also be problematic.

Aspects described herein enhance intelligent workflows and learn to help those providing, developing, implementing, and relying on intelligent workflows better adapt and optimize intelligent workflows. Examples include enhancements in the live user experiences of existing implemented/deployed intelligent workflows whose users encounter difficulties in adoption and successful progression through their digital experience. Aspects can be applied to a variety of industries, use cases, and help center training simulations (as examples), acting as artificial intelligence over an intelligent workflow's innovation, while helping to detect, monitor, and offer/identify insights into, potential inefficiencies such as low adoption, long transaction times, and poor implementation of the digitization of an intelligent workflow, as examples. Modalities of aspects described herein can embody chatbots, live, and offline analysis capabilities, and translate them to steps, events, and actors in intelligent workflow flows. Additionally, captured insights that are correlated together can be federated to other intelligent workflows, help inform better design processes for intelligent workflows to be developed, and customize and self-correct user experiences, as examples.

Some examples of use cases for aspects described herein include, but are not limited to:
Intelligent workflow orchestration and experience capturing by identifying bottlenecks that inhibit adoption and use;
Self-building training material from artificial intelligence that, by identifying the bottlenecks across different customer segments and populations, can identify more purposeful training material and speed up support;
Improvement/optimization of online process for customers, such as opening a bank account, buying a car online, buying groceries online, booking movie tickets online, etc.;
Simplifying a complex business process;
Understanding steps where most users become stuck; and
Supporting customers/agents with training material or help material to improve help processes.

In embodiments, aspects act upon an existing implemented/deployed intelligent workflow that works with entities and monitors the value that the intelligent workflow adds to the entities, while learning and self-updating itself to correct and improve the overall experience of users. In embodiments, aspects help maintain an intelligent workflow portfolio (referring to a collection of intelligent workflows of a provider), while remaining agile and responsive to market evolution. In embodiments, aspects can generate customized training materials to help support intelligent workflow implementation, improve intelligent workflow accessibility, and reduce bottlenecks in intelligent workflows. In embodiments, aspects can learn (and improve on) knowledge and insights, garnered from intelligent workflow interactions, at a federated level, and generate recommendations and training materials to help support intelligent workflow implementation, improve accessibility, and reduce bottlenecks, with deep insights per industry or other segment. In embodiments, aspects can help root cause analysis to aid helpdesk and support teams and improve their training knowledge and recognized ticket scenarios. In embodiments, aspects can authenticate and monitor intelligent workflow usage across various channels, such as mobile, web, and kiosk, and can assess the impact of removing a set of activities across all existing running flows, to help identify gaps. In embodiments, aspects can detect modality (the best experience for a user to consume a specific intelligent workflow) for effective engagement, and shift modality, as necessary, accordingly. In embodiments, aspects can help with optimization and adoption of new and existing intelligent workflows.

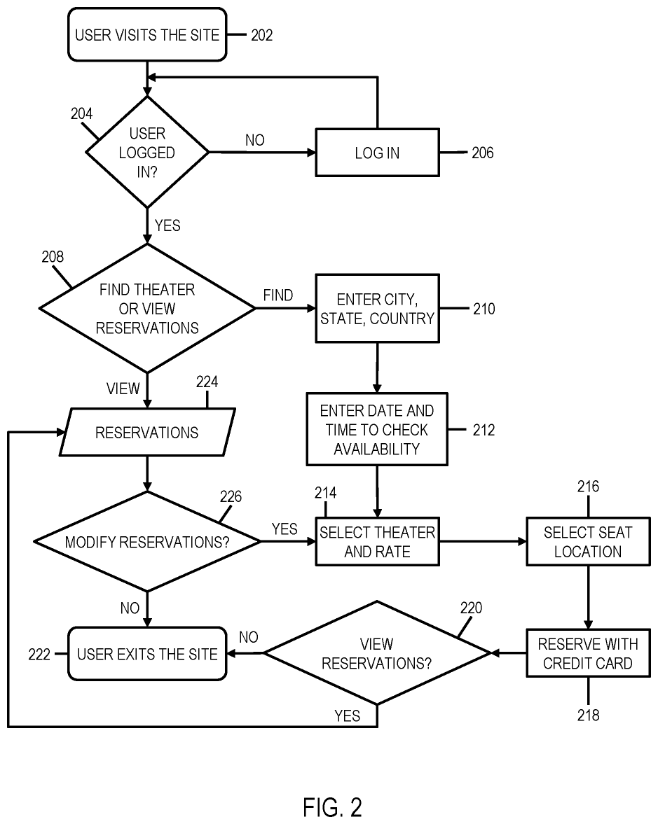

FIG. 2 depicts an example process implemented using an intelligent workflow. The example process of FIG. 2 shows a basic process for booking movie theater tickets. The user visits the website (202) and the process inquires whether the user is logged in (204). If not (No), the process proceeds with the user logging in (206), then returns to 204. After having logged in, or if the user was already logged in, inquiry 204 is answered in the affirmative (Yes) and the process proceeds with an inquiry (208) whether the user selects to find a theater based on location or instead desires to view the user's existing reservations. If the user selects to find a theater (Find), the process proceeds with the user entering the user's city, state, and country (210) and progress further with the user entering a date and time (212) to check availability for that date/time. Based on a search and provision of search results to the user, the process proceeds with the user selecting a theater and rate (214), then selecting a seat location (216). With these selections made, the user proceeds by reserving/booking the selection with a credit card (218). At this point, the process inquires whether the user has selected to view the user's existing reservations (220). If not (No), the process proceeds with the user exiting the website (222). Otherwise (Yes), or if at 208 the user had instead selected to view the user's existing reservations (View), the process proceeds with the user viewing the user's existing reservations (224). The process proceeds with an inquiry (226) as to whether the user has selected to modify an existing reservation. If so (Yes), the process proceeds to 214 where the user is prompted to select a theater to which the reservation is to be modified, otherwise (226, No), the process proceeds to 222 where the user exits the website.

One or more intelligent workflow(s) can execute on computer system(s) to progress through the process of FIG. 2. An intelligent workflow can include computerized activities (such as those of FIG. 2) through which a user progresses through interactions with the intelligent workflow via a graphical user interface. These interactions facilitate and reflect progression of the user through the intelligent workflow, and this progression can be monitored and recorded, for instance in data records. By way of specific example, recording the interactions includes production of logs, screen recordings, voice recordings, and/or chatbot, text, or other chat sessions between the user and an assistant, which provides for the capture all different types of interactions across the varying modalities through which users might interact with the intelligent workflow, and therefore capture a better quality sample set of user interactions.

In this scenario, users might find challenges locating a theatre even after they have entered their city, state, and country. These challenges are features that can be identified from the monitored/recorded progressions, reflected in the stored data records, and which can be extracted and analyzed.

Various approaches may be taken to help address challenges identified from the monitored progressions. Aspects described herein can suggest an improvement to the intelligent workflow, for instance a training action, such as a pop-up notification asking the user if the user needs help, and a subsequent suggestion to assist the user. If the user confirms that help is needed, then in some embodiments a system begins to record the process/subsequent interactions and can provide a video or otherwise assists the user in finding a nearby theater. Training actions can include video-based training, text communications, chat sessions with a live or AI-based/automated agents, etc., which provides varying types of assistance and approaches for training. This means the training can be tailored to different types of individuals who might train better through different approaches, thus making the automated training more efficient and specific to the individual users who need it.

As another example challenge, a bottleneck is observed in that some users, when performing a credit card transaction at 218, become stuck if using a particular type of credit card and are unable to proceed. In this case, aspects can assist the users by providing necessary guidance to address or help address the problem, for instance to assist the user in conveying proper credit card information or by suggesting use of a different type of card, as examples. As a corollary, if many users become stuck in the step of finding theaters (208 to 210), aspects could recommend a change to the intelligent workflow (e.g., a suggestion to replace or supplement an activity step), for instance by automatically suggesting nearby theatres based on sensing the user's current location or a preconfigured preferred location.

Intelligent workflows include a set of one or more activities, with each activity including a respective one or more steps. The activity flow refers to the progression through the activity/activities. Each step of each activity is associated to a respective acting entity/actor (such as a person/persona/user) and may be completed in sequence or parallel relative to other step(s). Each actor therefore has a set of step(s) associated to that actor, and that set of step(s) could include step(s) across one or more activities. Progression through the intelligent workflow generally involves progression from one activity to a next by performance of the steps in each activity by the involved actor(s) and based on successful progression from one step to a next step. In the context of aspects described herein, an end user, or just “user”, may be a reference to a person and/or an associated user computing device that progresses through step(s)/activities of the workflow in conjunction with other acting entities. Pathways informed by the interactions can indicate success or failure (‘blocking’) depending on whether the interactions are successful of unsuccessful in progressing through the workflow. Such successes and blocks can be identified and indicate a block of the intelligent workflow as a whole—referring to successful completion of the intelligent workflow from start to finish—and/or for individual steps, activities, or collection of steps/activities, as desired.

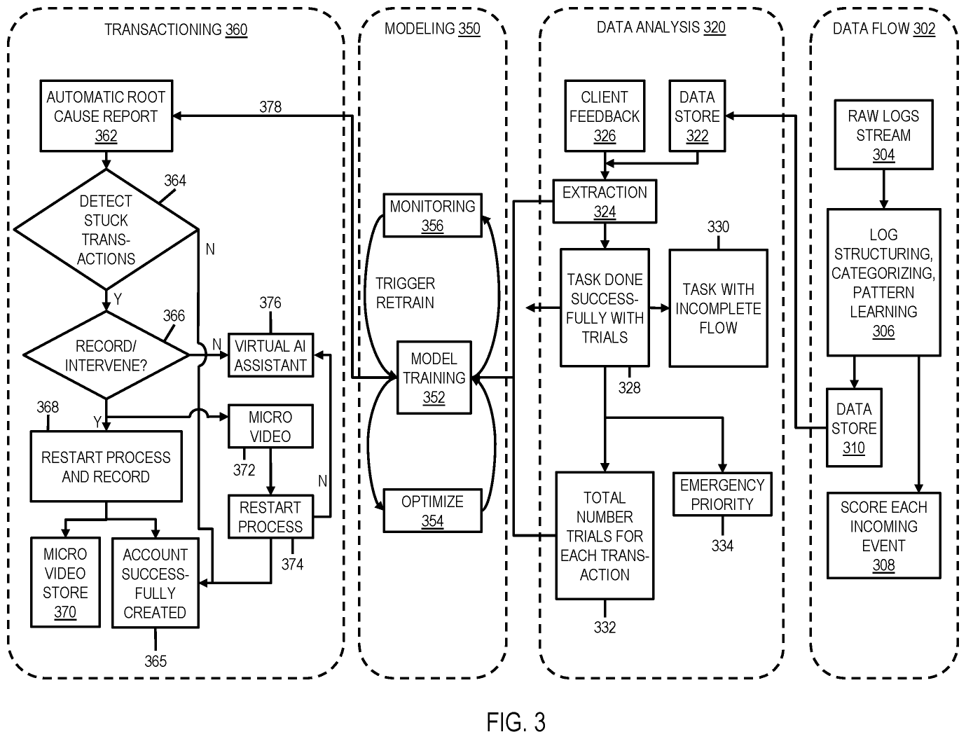

FIG. 3 depicts a conceptual diagram of the relation and flow between components of an intelligent system in accordance with aspects described herein. The intelligent system can be implemented/embodied by a combination of hardware and software, for instance one or more computer systems and one or more modules as described herein.

The system of FIG. 3 includes a data flow component 302 encompassing the capture, recording, or obtaining of raw log streams 304, and log structuring, categorizing, and pattern learning 306 (for instance using unsupervised machine learning) on the raw log streams. The structuring, categorizing, and pattern learning 306 structures the raw log streams into usable and/or harmonized format(s) (as log streams from different systems may be different in terms of their structure/format), categorizes the logged events/actions as desired, and learns patterns exhibited in the logs. Log streams provide logs of any desired event/actions. Logged events might describe interactions, and characteristics thereof, that occur as part of the intelligent workflow, including successful and unsuccessful interactions in terms of progressing a user from one step to another. Logged events could also indicate blockers, timeouts, and other indicators of problems, bottlenecks, challenges, and the like.

Data records other than log streams/events could be produced to log the interactions and characteristics thereof. Recordings of user interfaces (screen recordings) from user devices, voice recordings, helpdesk or other assistant conversations could be recorded and provided to the data flow component 302. Other types of information to analyze and learn from may be recorded.

Incoming events, interactions, results, or characteristics exhibited by the monitored/recorded progressions can be scored (308) on any desired scoring dimension and according to any desired methods, and the data flow component can store its results to a data store 310. Accordingly, the activity of the data flow component (or another component, e.g., monitoring component 356) can provide monitoring and recording of the progressions of users through intelligent workflows to produce stored data records. This includes monitoring/recording during whole or partial sessions/engagement with one or more intelligent workflows. For instance, the monitoring/recording can be performed as a continual process taking place before, during, and after performance of aspects described herein, such as generating and providing customized recommendations for improvement in intelligent workflow(s).

The intelligent system also includes a data analysis component 320 for performing data analysis on the data provided from the data flow component 302. Data analysis component 320 encompasses a database/storage device 322, which could be the data store 310 of data flow component 302 or a different data store. The data analysis component 320 performs data analysis, for instance extraction 324 of features of the monitored/recorded progressions, as reflected by the data from the data store 310 and provided in data store 322. Additionally in this example, client feedback 326 as to user experience and other aspects of the subject intelligent workflow(s) may also be provided in conjunction with the data from data store 322 for analysis and extraction of features of the interactions and progressions of users through the intelligent workflow(s). Extracted features can include any desired features that may be identified from the data analyzed. Example features include detected bottlenecks in progression through an intelligent workflow. Bottlenecks can determined based on, or informed by, the following, in examples: time taken to progress through aspect(s)—one or more steps, activities, or the entire workflow—of the workflow; cancellations or time-outs in progression through aspect(s) of the workflow; number of trials or attempts to perform actions; speed of successful or unsuccessful interactions; number of interactions to progress through aspect(s) of the workflow; number of steps and/or activities of the workflow; level of expertise needed to progress through the workflow; number, extent, level, and/or duration of assistance provided to user(s) in progressing them through aspect(s) of the workflow; and complexity of aspect(s) of the workflow. These are just some examples of the features that may be extracted to determine/indicate bottlenecks. These markers can be used in conjunction with preconfigured information, such as thresholds, defining what constitutes a bottleneck in terms of any/all of the foregoing. Exceeding threshold(s) for one of more of the markers/metrics could inform that a bottleneck is present, for instance. It is noted that a bottleneck does not necessarily correspond to a blocker, failure, error, or unsuccessful interaction per se; a bottleneck could be taken as something that violates a threshold. For example, an entity for which an intelligent workflow is deployed might define a threshold (e.g., maximum) of 10 seconds to complete for any step of the intelligent workflow. If the average time to complete that step is found to be 14 seconds, though all users are successful in progressing through that step, then this might be considered a bottleneck nonetheless, even though the logs would not necessarily reflect errors or blockers having occurred.

Further, extracted features can include features of successful and/or unsuccessful interactions with the intelligent workflow, and/or could be grouped according to any shared properties, for instance the expertise level of the users, modality of interaction with the intelligent workflow, or other properties.

Feature extraction can be on a per-intelligent workflow basis and/or on an aggregated basis across a collection of intelligent workflows that have been monitored. In the example data analysis component 320 of FIG. 3, the extraction identifies (328) tasks completed successfully with many trials (‘many’ being well-defined by a threshold, function, etc.), as well as tasks with flows not completed (330), and (332) total number of trials for each interaction between the users and the subject intelligent workflow(s). The data analysis component 320 can also extract or identify priorities/priority levels 334 associated with the tasks.

Modeling component 350 of FIG. 3 builds and trains AI model(s) described herein using the extracted features provided by the data analysis component 320. For instance, models(s) to score performance of specific intelligent workflow(s) can be built, though other types of models are possible and discussed herein. In general, a modeling lifecycle of 350 includes model building and training 352 (based on features from data analysis 320 and feedback from transactioning component 360, as examples), optimization 354, and triggered retraining based on monitoring 356 that occurs. Monitoring component 356 refers to the ongoing monitoring discussed above relative to the data flow component. Optimize module 354 refers to the model training/retraining that can occur as frequently as desired.

Modeling 350 provides learning models that can be useful in generating customized, tailored recommendations for improvement in intelligent workflow(s). These recommendations can work in conjunction with, and for implementation by, transactioning component 360 of the intelligent system of FIG. 3. The transaction component 360 has a view to transactions/interactions that either have occurred or are in the process of occurring between users and workflow(s). Based on observed interactions, AI model(s) of the modeling component 350 can be applied to generate recommendation(s) that can then be output. The monitoring, feature extraction, model building/training, generating and outputting of recommendations provides a lifecycle for improvement of existing, deployed intelligent workflows, restructuring of existing intelligent workflows for new applications, industries, modalities, etc., and insights to apply when developing new intelligent workflows.

By way of specific example, transactioning component 360 operates in the example of FIG. 3 in connection with a customer's interactions with an intelligent workflow to create an account with an online service after visiting the service's website. The transactioning component 360 analyzes a report (362), as one example of an indication of user progression through a workflow, and determines (364) whether a stuck transaction is present. If not (No), the intelligent workflow ends with the account being successfully created (365). Otherwise, a stuck transaction is detected (Yes). At this point, a process, such as a chatbot or other AI-based assistant, asks (366) the user for permission to intervene (and in this case record the interactions between the user and the workflow and/or assistant from that point). The process will continue by restarting (368) progression of the intelligent workflow from some point prior to where the transaction became stuck, for instance from a step that caused the struck transaction or a prior step of the intelligent workflow, and, in this example, store the recording to a video store 370. The video store 370 may be a data source for the data flow component 302 and subsequent data analysis component 320 explained above. In this regard, the user may retry the step and, now based on the system video/screen recording the progression from there as a video of the screen interactions, this provides additional progressions for further analysis (via 320) of a root cause for the stuck transaction.

Meanwhile, in the example of FIG. 3 another action is performed in addition to restarting progression through the intelligent workflow: the process will intervene by, in this example, dynamically presenting/outputting a video 372 to the user device and for the viewer to view. As an example, the video could be a demonstration of a successful transaction/interaction with the intelligent workflow at the point at which the user is stuck. The video could thereby demonstrate for the user how to successfully complete the step on which the user is stuck by presenting a recording of the interactions that another user performed to successful complete the step, for example. By way of specific example, in a situation where a user becomes stuck at a step because the user is to scroll down in the interface to view and click a ‘Submit’ button to progress onward, the video could be a screen recording showing a scroll action to scroll downward in the interface in order to reveal a Submit button for the user to click. The video in this case could be one recorded of another user progressing through the workflow or could be one not recorded from a real interaction scenario—an animation for instance. In some examples, a recorded video is augmented with graphical elements to highlight interface elements, such as input boxes, buttons, sliders, or other interactive interface elements, animations, descriptions, or highlights of actions the user should undertake in interacting with the user's device, or any other augmentations to show the user a successful progression.

A video display for the user constitutes a training action that is output to the user. Other examples training actions include presentation of text communications or initiation of a live chat session (virtual or with a human help agent; text-based, telephone-based, etc.), as examples. More generally, help patterns might exist to assist users in situations where interactions are unsuccessful, a bottleneck is present, or other reasons. Such assistance may be provided even proactively, for instance based on predicting that the user will experience a problem or that some kind of assistance will otherwise be helpful.

Help patterns are one form of customized recommendation for workflow improvement and focus primary on helping users progress through an intelligent workflow. Other types of customized recommendations, for instance suggestions for how to improve aspects of workflow design, implementation, and/or deployment are also possible. Customized recommendations can be learned and provided through the processing of the data flow, analysis, and modeling components of FIG. 3. From monitored interactions, extracted features might show that one particular group of users are significantly more successful and another group of users at a given step. The data analysis component can identify interactions, at that step, that are successful as well as interactions that are not successful, and then group the successful and unsuccessful interactions, for instance. It can then be gleaned by looking at the properties of those groups of interactions that the one group of users is statistically much more likely to successfully progress through the step on their first try, whereas the second group of users is statistically very likely to become stuck at that step. By way of specific example, the first group of users might be users who have location services enabled to their web browser, while the second group has location services disabled, and therefore, the intelligent workflow has trouble with a step that attempts to automatically detect user location. Based on this, a model might determine a help pattern that presents a video or performs some other training action to a user demonstrating how to enable location services and/or how to progress to another step to input the user's location, as an example.

Referring back to FIG. 3, the process restarts (e.g., at 368 after beginning recording and/or at 374 either during or after presenting the video 372). In situations where the user is no longer stuck after restart, the account is created successfully (365). If the user does not want intervention from 366 (No), or if a decision or selection is made not to restart the process after viewing the video (374, No), the process proceeds by directing the user to a virtual AI assistant (376), in this example.

The particular customized recommendations employed by the transactioning component 360, or in the case of a help action the particular action(s) to attempt, may be informed from the modeling component 350 via communication 378 between the two entities, and based on apparent problem(s) experienced. If the problem is an issue with the formatting of user input, a notification, video, or the like presented to a user might inform of the proper format and/or show how to provide the input in the proper format. In general, the help action can be something that an AI model learns and predicts to be successful to address the issue. What is predicted to be helpful can be learned by analyzing monitored interactions of this or other intelligent workflow(s) and extracting features that inform what results in successful (versus unsuccessful) interactions at that given step. As a basic example, the features might indicate that numeric user input, rather than alphabetic characters, are required to progress in the intelligent workflow at the point at which the user becomes stuck. A model might identify this requirement. The same or a different model might identify that this particular user is likely to experience a blocker at this step due to improper input. The same or a different model might identify an action to take, either proactively before the user hits the blocker or in response to the user hitting the blocker, for instance an action to show or otherwise indicate to the user that the input is to be numeric and not alphabetic characters.

Accordingly, aspects described herein can generate customized training materials to help support intelligent workflow implementation, improve accessibility, and reduce bottlenecks, as examples. In a specific example, a process analyzes and divides/groups interactions of one or more intelligent workflows (for instance all intelligent workflows for opening a bank account) and distributes the interactions into one of three disjoint classes: (i) interactions that were successful in progressing the user through the given intelligent workflow, (ii) interactions that did not involve engagement between the user and an AI assistant and that resulted in abandonment of the task progression through the intelligent workflow, and (iii) interactions that did involve engagement between the user and an AI assistant but that resulted in abandonment of the task progression through the intelligent workflow. A fourth class, one that groups together interactions that involved a support ticket on the specific intelligent workflow, could also be used. Then, for each of the aforementioned classes and/or on an aggregate basis across users in the classes, the feature extraction can extract/record the following features (as examples):
time spent per activity, referring to some amount of time (total for a given sample, average or median across samples, etc.) to progress through an activity;
demographics, referring to one or more demographics of users having the subject interactions;
number of trials on the given step, referring to total attempts made to progress through the given step;
average speed of successful progression through step(s);
number of instances of missing information in an information field;
number of interactions user(s) have with an AI assistant, such as a total number across all of the aforementioned classes;
instances of natural language processing used against interaction responses with an AI assistant;
instances of natural language processing used against support ticket(s) associated with intelligent workflow(s);
number of trials on the intelligent workflow, referring to a number of attempts for users to progress through the intelligent workflow;
level of digital expertise of the users and/or familiarity of the users with a deploying entity, for instance an indication whether users tend to be new or existing customers, and sophisticated or unsophisticated in interacting with intelligent workflows;
modality, referring to the engagement channel (e.g., mobile, web, kiosk, voice, etc.) through which the user engages with the intelligent workflow;
number of AI assistant interactions taken, per step, referring to a reflection of the degree of help needed to help progress user(s);
number of total steps in the intelligent workflow(s);
number of total activities in the intelligent workflow(s); and/or
complexity of the intelligent workflow.

The above can be considered on a singular basis (per user, per session, per intelligent workflow, etc.) and/or on an aggregated basis (across users of a given intelligent workflow, across users who attempted a given step, across workflows that incorporate the same/similar step, etc.).

With the features collected, one or more AI models can be built. One such model is a model that is trained to identify a specific intelligent workflow from among a collection of available intelligent workflows, for instance to distinguish between an intelligent workflow for opening a bank account and one for closing a bank account, as an example. Such a model may be trained on the various steps of the flows, types of input values provided at each step, and expected output at each step, with distinctions made between at least successful and unsuccessful progressions between consecutive steps. Another example AI model is a customer classifier model that is trained to help an AI assistant determine, in real time as a user interacts with an intelligent workflow and from the observed interactions, an amount of help the user actually or is expected to need, and potential blocker points of the intelligent workflow. This model may be or incorporate, for instance, a neutral network trained to identify an expertise level of the user. A second, multiclass, AI model (e.g., as a neural network) can be built and trained to identify and rank potential bottleneck steps, and this could be done for each of the expertise levels. The bottlenecks to expert users may be expected to differ from bottlenecks to beginners. Aspects can learn, from the monitoring and feature extraction, the expertise levels of users, and this can be for users of a single entity (since customer of the intelligent workflow provider) and/or across users of a collection of entities. An additional example AI model is a support ranking model that is trained to rank severity of support/helpdesk incidents into a collection of classes, for instance high severity, medium severity, and low severity. The model can also be trained to open an incident/ticket in the background for any intelligent workflow that was found to be abandoned by a user where the user has not opened an incident/ticket. As yet another example AI model, a scenario simulation model could be generated that combines the above-noted models and is parametrized to generate customer profiles and associated combination of steps, interactions, and events to simulate low, medium, or high severity incidents. In a particular example, a generative model based on generative adversarial network(s), deep learning, and/or machine learning could be used depending on the complexity of the generation.

Additional aspects provide for learning and improvement in knowledge and insights gained at a federated level, and generation of recommendations and training materials to help support intelligent workflow implementation, improve accessibility, and reduce bottlenecks, with deep insights per industry, intelligent workflow type, user demographic, modality/channel of user engagement, and any of various other properties and characteristics about which features may be extracted based on monitoring intelligent workflow progressions and interactions. Aspects can authenticate and monitor usage from various channels, such as mobile, web, kiosk, etc., can assess the impact of removing a set of activities/steps from existing deployments of intelligent workflows, identify gaps, detect optimum modality (the best experience for a user to consume a specific workflow) for effective engagement, and shift or emphasize modalities accordingly. In the example of a bank account creation process, an optimization might be for the user to take a screenshot of the application when connecting from a mobile device, or to automatically read from a received communication and propagate into the application a multi-factor authentication value when attempting to authenticate with the application.

The features and associated learnings garnered from monitoring and analyzing interactions of one particular deployed intelligent flow for one particular entity can be federated on multiple dimensions. One such dimension is among similar entities implementing the same intelligent workflow under similar user demographics. For instance, an intelligent workflow implemented for one entity (a bank) for digitization of account opening may not be well adopted among the entity's clients or might conflict with a strategy prevalent in the entity's industry (banking industry). Federated insights extracted using AI models as described herein can be correlated to other entities within and without that industry in order to build a model that classifies the intelligent workflow's digital fitness and potential for accuracy and alignment with that other entity and/or the industry in which that entity sits. Furthermore, adjustments in modality, training, and education that showed adoption improvements can be leveraged by other entities as well at the industry level. Another dimension is within the same client departments as within the same industry, where intelligent workflows can share common events and steps, such as a first intelligent workflow (for account opening) that shares a user information and user profile related step with a second intelligent workflow (for account closing). If the first intelligent workflow encounters issues in digitization and the models above classify it as high complexity with a low adoption profile and many support issues with specific steps, this insight may be useful in improving the second intelligent workflow. For instance, the insight can be federated to an intelligent workflow digitization, as an AI model trained to identify a specific intelligent workflow among a collection of available intelligent workflows can classify the two intelligent workflows (first and second above) as similar and identify problematic steps, for instance potential blocker steps and events, in the second intelligent workflow if it was proposed to be used elsewhere. An analysis insight might recommend a customization of that second intelligent workflow, for instance, or the modality experience to use in order to avoid some of the problems observed with the first intelligent workflow.

Improvement in intelligent workflows has technical effects of increasing efficiency in data and digital communication between computer systems engaging in and/or hosting processing of the workflow steps and activities. Improvements provide reduced session durations, retry attempts, repeated communications, and the like, and improve transaction processing, which in turn reduces processing power and resources needed in executing the intelligent workflows. Additional improvements are provided in the form of optimized automated training systems, and smarter and more effective AI assistants and chatbots. Additionally, optimized and more efficient intelligent workflows improve entity digital presence by reaching to more users and new markets, improve customer satisfaction by improving customer experience, increase customer retention through multiple modalities and better experiences while executing transactions, increase customer base, decrease costs in supporting customers through helpdesk/agents, and provide a measure of quality and cost saving by adopting quality intelligent workflows for business process.

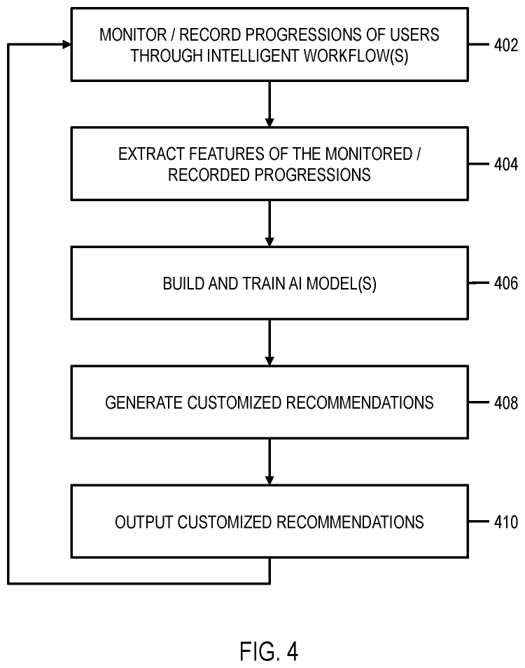

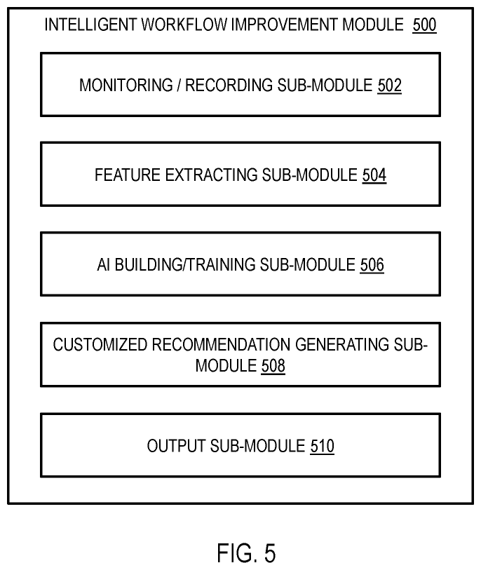

FIG. 4 depicts an example process for AI-based intelligent workflow improvement, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 4 are part of a module, such as module 500 of FIG. 5. In other examples, the code may be included in one or more modules and/or in one or more sub-modules of the one or more modules. Various options are available.

The process of FIG. 4 includes monitoring and recording (402) progressions of users through an intelligent workflow. The intelligent workflow includes computerized activities through which the users progress through interactions with the intelligent workflow via graphical user interfaces. The recording of these progressions can produce stored data records that reflect the interactions and properties thereof. In embodiments, the recording includes producing, as at least some of the stored data records: logs, screen recordings, voice recordings, and/or helpdesk conversations.

The process continues by extracting (404) features of the monitored and recorded progressions as reflected by the stored data records. The extracting can include analysis of the interactions for use in gain insights therefrom. The extracted features could include detected bottlenecks to progression through the intelligent workflow. For instance, the detected bottlenecks could include: time to complete one or more computerized activities of the plurality of computerized activities; time to complete one or more steps of the intelligent workflow; number of steps of the intelligent workflow; number of activities of the intelligent workflow; number of trials on a step of the intelligent workflow; number of trials of the intelligent workflow; number of interactions with an AI-based assistant; and/or rate of termination in progressing through the intelligent workflow, as examples.

The process builds and trains (406) at least one artificial intelligence (AI) model using the extracted features. In embodiments, a built and trained AI model is configured to classify, based on interactions of a user, an expertise level of the user, and identify a ranking of potential bottlenecks to the user in progressing through the intelligent workflow. In embodiments, a built and trained AI model is configured to classify instances of unsuccessful progression through the intelligent workflow by severity.

The process of FIG. 4 also generates (408), using the at least one AI model, customized recommendations for improvement of the intelligent workflow. The customized recommendations could include a training action for presentation to a user progressing though the intelligent workflow. The customized recommendations could additionally or alternatively include a recommended modality for users to consume the intelligent workflow in order to optimize their engagement with the intelligent workflow. The customized recommendations could additionally or alternatively include a recommendation to modify a step of the intelligent workflow, and/or a recommendation to supplement a step of the intelligent workflow with the training action. An example of such a supplement is to show a video or other demonstration to a user to help the user successfully progress through a step/activity of the intelligent workflow.

In embodiments, the process can also use the at least one AI model to generate customized recommendations for improvement in one or more existing intelligent workflows and/or the design of one or more intelligent workflows to be developed and deployed.

Based on generating the customized recommendations, the process proceeds by outputting (410) the customized recommendations. The outputting includes dynamically presenting the training action to the user on a graphical user interface through which the user interacts with the intelligent workflow as part of progressing through the intelligent workflow. In embodiments, the training action includes provision of a video, a text communication, and/or a chat session.

In an embodiment, the extracted features include features of successful interactions with the intelligent workflow. In a further embodiment, the building and training (406) the at least one AI model trains an AI model, using the features of successful interactions, to generate the training action to be presented based on detecting a bottleneck of the detected bottlenecks. In yet a further embodiment, the outputting (410) includes dynamically presenting the training action to the user based on actual or predicted presence of the bottleneck in the user progressing through the intelligent workflow. In one or more embodiments, an AI model learns, based on the training using the features of the successful interactions, how the bottleneck may be avoided.

In one or more embodiments, the process also groups the interactions based on user type, for instance an expertise level, a web modality used, or any other one or more properties, and/or an industry for which the intelligent workflow is deployed. In one or more embodiments, the generating (408) produces customized recommendations that vary across different user types, and/or different industries. As an example, a model can learn to classify expertise of a set of users and, for each learned expertise class, the most likely bottleneck(s) for users in that class.

In one or more embodiments, the process iterates over a length of time. For instance, the process can repeat, for each additional intelligent workflow of a plurality of additional intelligent workflows, the monitoring and recording progressions, and the extracting features, to produce additional sets of extracted features. In one or more embodiments, the building and training of the at least one AI model can use the additional sets of extracted features, and thus recommendations can be generated based on the model(s) build based on monitoring across intelligent workflows. In one or more embodiments, the monitoring and recording can monitor results of having generated and output the customized recommendations. This feedback can inform how successful the recommendations have been, if implemented. For example, the monitoring and recording can monitor results of having dynamically presented the training action to the user. The results providing feedback as to whether the training action is helpful in progressing though the intelligent workflow. This can be used in further training of model(s).

FIG. 5 depicts further details of an example intelligent workflow improvement module (e.g., intelligent workflow improvement module 500 of FIG. 1) to incorporate and/or use aspects described herein. In one or more aspects, intelligent workflow improvement module 500 includes, in one example, various sub-modules to be used to perform AI-based intelligent workflow improvement processing. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuity thereof, such as computer(s) 101, EUD 103, server 104, or computers of cloud 105/106 of FIG. 1, as examples.

Referring to FIG. 5, intelligent workflow improvement module 500 includes monitoring/recording sub-module 502 to perform monitoring/recording of progressions of users through intelligent workflow(s) (e.g., 402 of FIG. 4), feature extracting sub-module 504 to perform extracting features of the monitored/recorded progressions (e.g., 404 of FIG. 4), building and training sub-module 506 to perform building and training of AI models (e.g., 406 of FIG. 4), customized recommendation sub-module 508 to perform generating customized recommendations (e.g., 408 of FIG. 4), and output sub-module 510 to perform outputting the customized recommendations (e.g., 410 of FIG. 4).

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
monitoring and recording progressions of users through an intelligent workflow, the intelligent workflow comprising a plurality of computerized activities through which the users progress through interactions with the intelligent workflow via graphical user interfaces, the recording producing stored data records;
extracting features of the monitored and recorded progressions as reflected by the stored data records;
building and training at least one artificial intelligence (AI) model using the extracted features;
generating, using the at least one AI model, customized recommendations for improvement of the intelligent workflow, the customized recommendations comprising a training action for presentation to a user progressing though the intelligent workflow; and
outputting the customized recommendations, the outputting including dynamically presenting the training action to the user on a graphical user interface through which the user interacts with the intelligent workflow as part of progressing through the intelligent workflow.

2. The method of claim 1, wherein the extracted features comprise detected bottlenecks to progression through the intelligent workflow.

3. The method of claim 2, wherein the extracted features comprise features of successful interactions with the intelligent workflow, wherein the building and training the at least one AI model trains an AI model, using the features of successful interactions, to generate the training action to be presented based on detecting a bottleneck of the detected bottlenecks, and wherein the outputting includes dynamically presenting the training action to the user based on actual or predicted presence of the bottleneck in the user progressing through the intelligent workflow.

4. The method of claim 3, wherein the AI model learns, based on the training using the features of the successful interactions, how the bottleneck may be avoided.

5. The method of claim 2, wherein the detected bottlenecks comprise at least one of:
time to complete one or more computerized activities of the plurality of computerized activities;
time to complete one or more steps of the intelligent workflow;
number of steps of the intelligent workflow;
number of activities of the intelligent workflow;
number of trials on a step of the intelligent workflow;
number of trials of the intelligent workflow;
number of interactions with an AI-based assistant; and
rate of termination in progressing through the intelligent workflow.

6. The method of claim 1, wherein the at least one AI model comprises an AI model configured to classify, based on interactions of the user, an expertise level of the user, and identify a ranking of potential bottlenecks to the user in progressing through the intelligent workflow.

7. The method of claim 1, wherein the at least one AI model comprises an AI model configured to classify instances of unsuccessful progression through the intelligent workflow by severity.

8. The method of claim 1, further comprising grouping the interactions based on at least one of:
user type; and
industry for which the intelligent workflow is deployed;
wherein the generating produces customized recommendations that vary across at least one of different user types and different industries.

9. The method of claim 1, further comprising repeating, for each additional intelligent workflow of a plurality of additional intelligent workflows:
the monitoring and recording progressions; and
the extracting features, to produce additional sets of extracted features;
wherein the building and training the at least one AI model uses the additional sets of extracted features.

10. The method of claim 9, further comprising using the at least one AI model to generate customized recommendations for at least one of:
improvement in one or more existing intelligent workflows; and
design of one or more intelligent workflows to be developed and deployed.

11. The method of claim 1, wherein the recording comprises producing, as at least some of the stored data records, at least one of: logs, screen recordings, voice recordings, and helpdesk conversations.

12. The method of claim 1, wherein the training action comprises provision of at least one of: a video, a text communication, and a chat session.

13. The method of claim 1, wherein the monitoring and recording monitors results of the dynamically presenting the training action to the user, the results providing feedback as to whether the training action is helpful in progressing though the intelligent workflow.

14. The method of claim 13, further comprising recording a video of interactions by the user in conjunction with the dynamic presentation of the training action, and providing the video as part of the results, wherein the generating generates a customized recommendation, of the customized recommendations, to include the video.

15. The method of claim 1, wherein a customized recommendation of the customized recommendations comprises a recommended modality for users to consume the intelligent workflow in order to optimize their engagement with the intelligent workflow.

16. The method of claim 1, wherein the customized recommendations comprise at least one of:
a recommendation to modify a step of the intelligent workflow; and
a recommendation to supplement a step of the intelligent workflow with the training action.

17. A computer system comprising:
a memory; and
a processor in communication with the memory, wherein the computer system is configured to perform a method comprising:
monitoring and recording progressions of users through an intelligent workflow, the intelligent workflow comprising a plurality of computerized activities through which the users progress through interactions with the intelligent workflow via graphical user interfaces, the recording producing stored data records;
extracting features of the monitored and recorded progressions as reflected by the stored data records;
building and training at least one artificial intelligence (AI) model using the extracted features;
generating, using the at least one AI model, customized recommendations for improvement of the intelligent workflow, the customized recommendations comprising a training action for presentation to a user progressing though the intelligent workflow; and
outputting the customized recommendations, the outputting including dynamically presenting the training action to the user on a graphical user interface through which the user interacts with the intelligent workflow as part of progressing through the intelligent workflow.

18. The computer system of claim 17, wherein the extracted features comprise detected bottlenecks to progression through the intelligent workflow and features of successful interactions with the intelligent workflow, wherein the building and training the at least one AI model trains an AI model, using the features of successful interactions, to generate the training action to be presented based on detecting a bottleneck of the detected bottlenecks, and wherein the outputting includes dynamically presenting the training action to the user based on actual or predicted presence of the bottleneck in the user progressing through the intelligent workflow.

19. The computer system of claim 17, wherein the method further comprises:
repeating, for each additional intelligent workflow of a plurality of additional intelligent workflows: the monitoring and recording progressions; and the extracting features, to produce additional sets of extracted features; wherein the building and training the at least one AI model uses the additional sets of extracted features; and
using the at least one AI model to generate customized recommendations for at least one of: improvement in one or more existing intelligent workflows, and design of one or more intelligent workflows to be developed and deployed.

20. A computer program product comprising:
a computer readable storage medium readable by a processing circuit and storing instructions for execution by the processing circuit to:
monitoring and recording progressions of users through an intelligent workflow, the intelligent workflow comprising a plurality of computerized activities through which the users progress through interactions with the intelligent workflow via graphical user interfaces, the recording producing stored data records;
extracting features of the monitored and recorded progressions as reflected by the stored data records;
building and training at least one artificial intelligence (AI) model using the extracted features;
generating, using the at least one AI model, customized recommendations for improvement of the intelligent workflow, the customized recommendations comprising a training action for presentation to a user progressing though the intelligent workflow; and
outputting the customized recommendations, the outputting including dynamically presenting the training action to the user on a graphical user interface through which the user interacts with the intelligent workflow as part of progressing through the intelligent workflow.
